(19) United States
(12) Patent Application Publication
(10) Pub. No.: US 2016/0237969 A1
(43) Pub. Date: Aug. 18, 2016

(54) Fuel Injection Valve

(71) Applicant: HITACHI AUTOMOTIVE SYSTEMS, LTD., Hitachinaka-shi, Ibaraki (JP)

(72) Inventors: Masanori MIFUJI, Hitachinaka (JP); Kiyotaka OGURA, Hitachinaka (JP); Eiji ISHll, Tokyo (JP)

(21) Appl. No.: 15/029,821

(22) PCT Filed: Oct. 14, 2014
(86) PCT No.: PCT/JP2014/077283

§ 371 Date: Apr. 15, 2016

(30) Foreign Application Priority Data
Nov. 7, 2013 (JP) 2013-230779

(51) Int. Cl. F02M 61/16; F02M 51/06; F02M 61/18

(52) U.S. Cl. CPC F02M 61/162; F02M 61/1806; F02M 51/0614

(57) ABSTRACT

An object of the present invention is to provide a fuel injection valve that imparts swirl upstream of a seat portion and shortens a spray penetration. At injection holes set adjacent to an injection hole and at injection holes set adjacent otherwise, nonuniform pitch angles β1 and β2 among the holes as well as stronger flows into the injection holes by a smaller angle α due to a smaller inflow angle β1 of a fluid into the injection holes can shorten the spray penetration at the injection hole.

### TECHNICAL FIELD

The present invention relates to a fuel injection valve for use in an internal combustion engine for an automobile.

### BACKGROUND ART

In internal combustion engines for automobiles, for example, an electromagnetic fuel injection valve driven by an electric signal from an engine control unit is widely used.

Fuel injection valves of this kind include those called a port injection type attached to an intake pipe for indirectly injecting fuel into a combustion chamber, and those called a direct injection type for directly injecting fuel into the combustion chamber.

In the latter direct injection type valves, a spray shape to be formed by the injected fuel determines combustion performance. Thus, it is necessary to optimize the spray shape in order to obtain a desired combustion performance. Here, the optimization of the spray shape can also be rephrased as spray direction and penetration.

Known as a fuel injection valve is one including a valve element provided movably, a drive means for driving the valve element, a valve seat which the valve element moves toward and away from, and a plurality of orifices provided downstream of the valve seat (see PTL 1).

### CITATION LIST

### Patent Literature

PTL: JP 2009-30572 A

### SUMMARY OF INVENTION

### Technical Problem

It is known that a spray to be ejected from a fuel injection valve is ejected nearly in an axial direction where an injection hole is machined. Like the fuel injection valve described in PTL 1, for a fuel injection valve of a type with a plurality of injection holes (orifices), it is required to increase machining accuracy in a direction of each injection hole. It is also required to control a penetration of the spray to be ejected from each injection hole to be shortened in order to avoid interference with a size of an inside of a combustion chamber, a shape of a piston surface, and a valve for air control (inlet valve and exhaust valve) as much as possible for reducing generation of exhaust as components (such as soot, an unburned gas component, in particular).

In the fuel injection valve described in PTL 1, the spray penetrations at the injection holes are not taken into consideration. As a method for controlling the spray penetration at each injection hole, it is possible to change diameters of the injection holes. Generally, the spray penetration at each injection hole can be controlled by setting a hole diameter size larger at an injection hole for lengthening the spray penetration and smaller at an injection hole for shortening the spray penetration.

However, in a case where the hole diameters of the injection holes are changed, it is necessary to prepare a plurality of tools for machining the hole diameter in accordance with each injection hole and carry out machining using different tools for each injection hole. This also leads to higher costs of manufacturing the fuel injection valves.

In order to use different tools in machining the injection holes, it is necessary to change the tools or move a material for forming the injection holes to other machining device. Therefore, a relative position deviation may be caused between the tools and the material, and machining accuracy of injection holes may decline.

An object of the present invention is to provide a fuel injection valve that can suppress fuel adhesion to the inside of the combustion chamber and the piston by controlling the penetration of the spray to be ejected from the injection hole, and that can improve exhausting performance (particularly suppression of unburned components).

### Solution to Problem

The object of the present invention can be achieved by, as an example, shortening a penetration of a spray to be ejected from a first injection hole, among a plurality of injection holes, set on a central axis with a center of a connector portion as an axis as well as controlling penetrations of sprays to be ejected from other injection holes.

### Advantageous Effects of Invention

According to the present invention, it is possible to provide a fuel injection valve that can suppress fuel adhesion to an inside of a combustion chamber and a piston by controlling a penetration of a spray to be ejected from each injection hole, and that can improve exhausting performance (particularly suppression of unburned components).

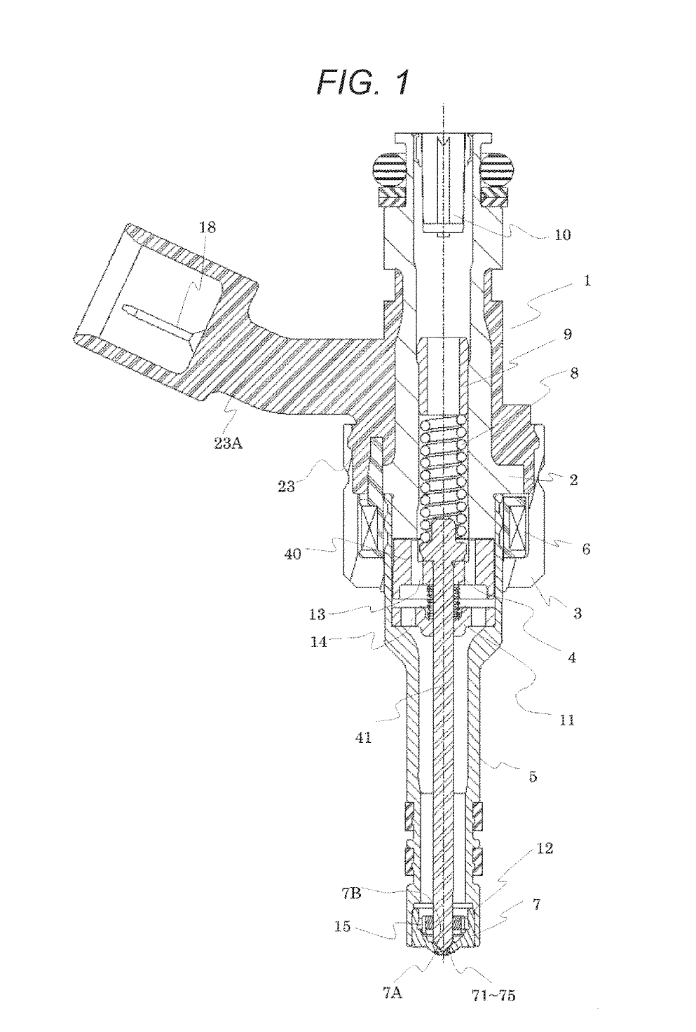

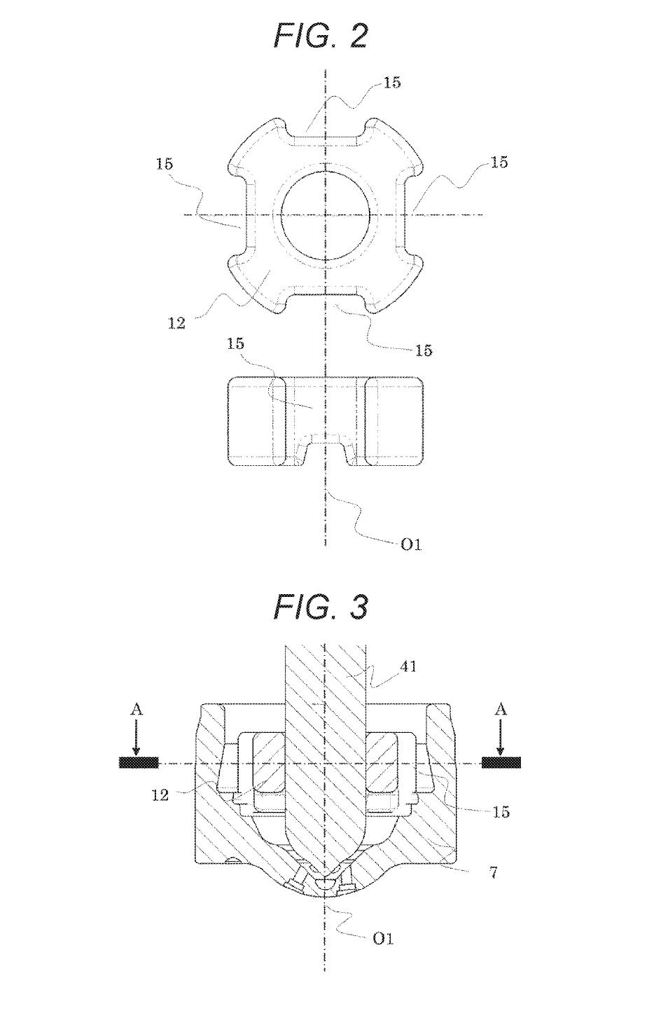

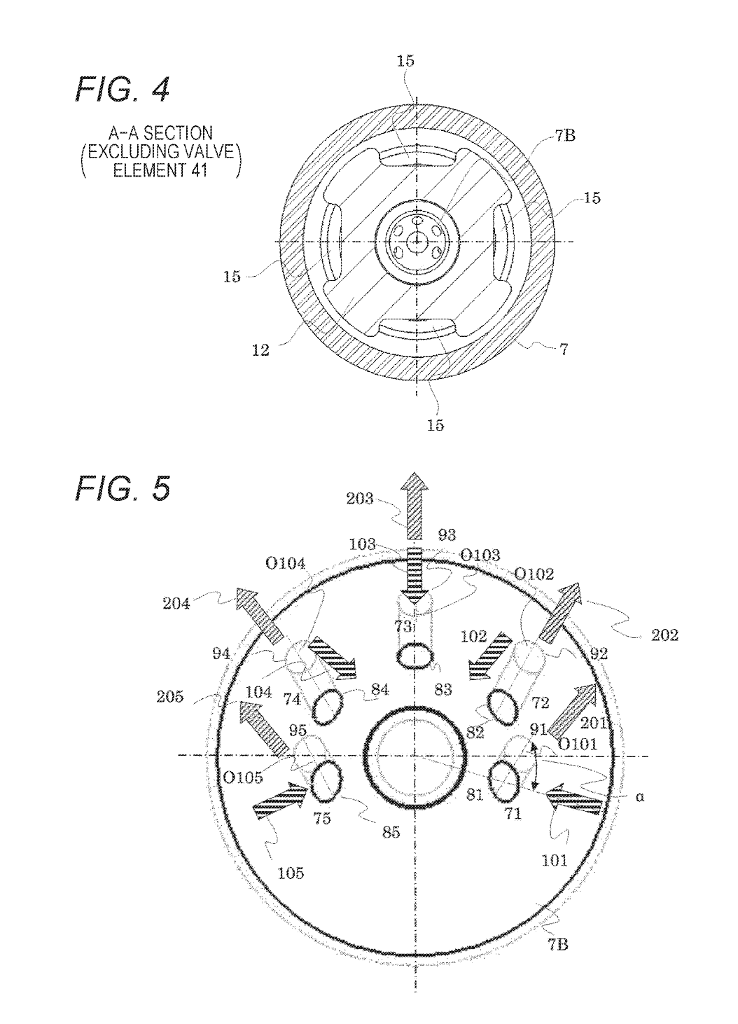

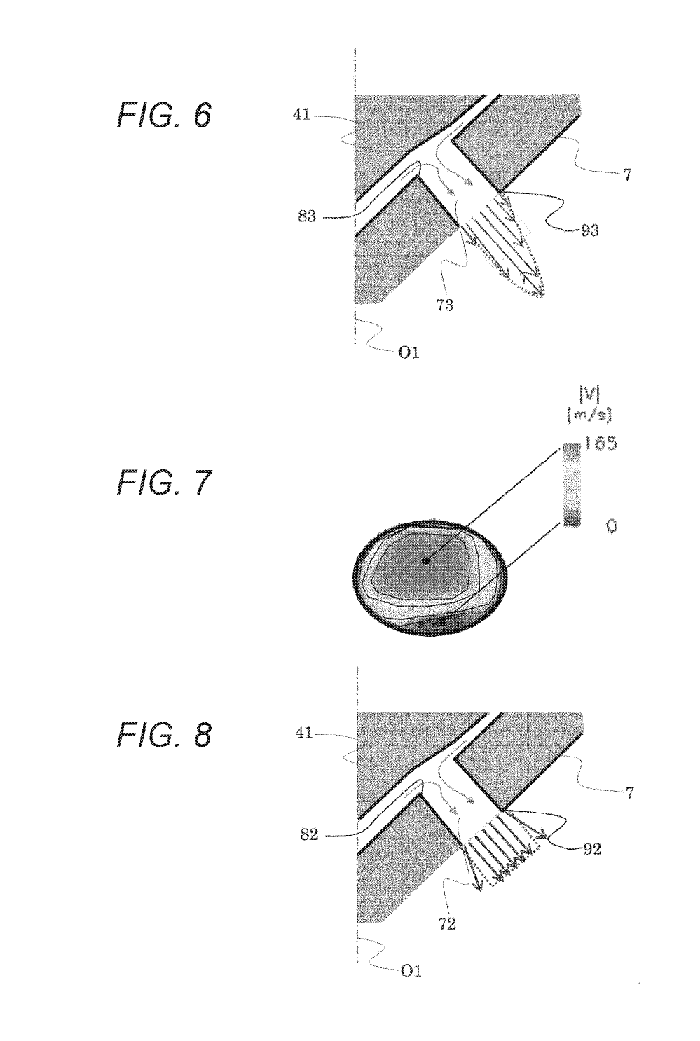

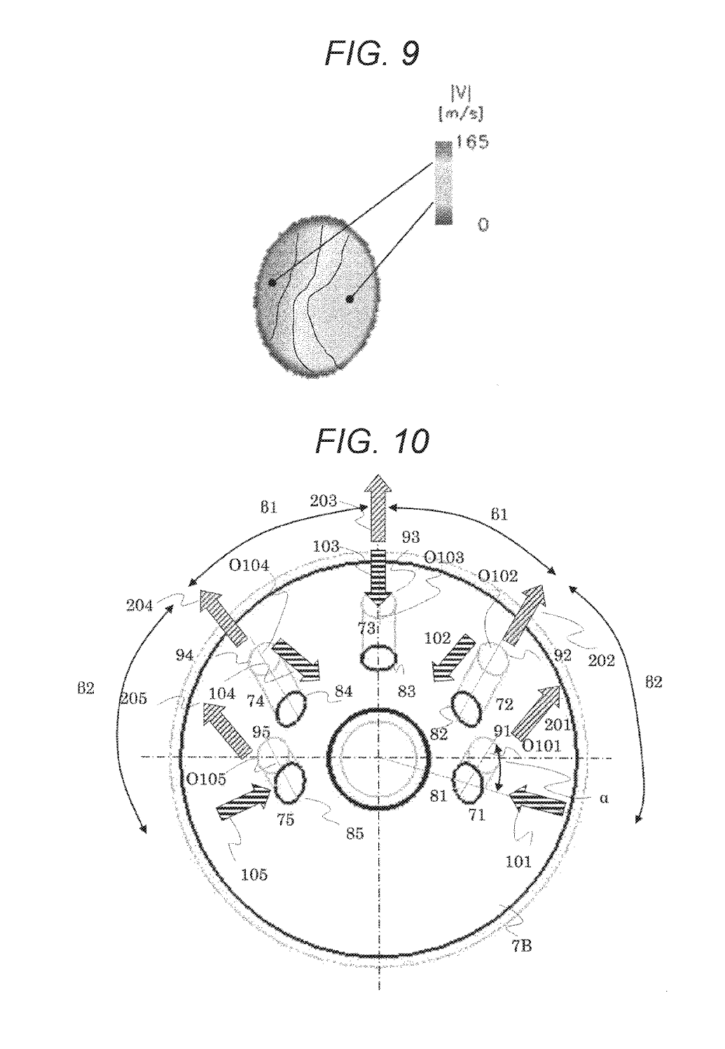

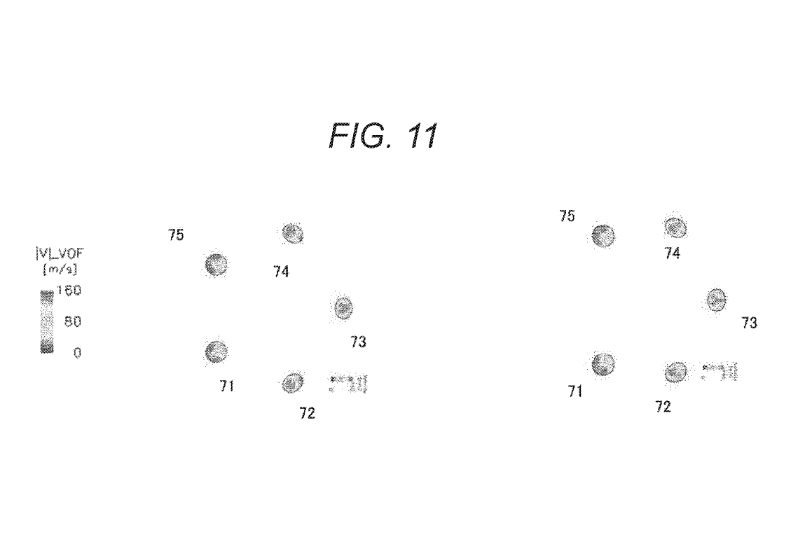

### BRIEF DESCRIPTION OF DRAWINGS

[FIG. 1] FIG. 1 is a longitudinal sectional view illustrating an overall configuration on of a fuel injection valve according to an embodiment of the present invention.

[FIG. 2] FIG. 2 is top and side views of a guide member.

[FIG. 3] FIG. 3 is a longitudinal sectional view illustrating a vicinity of an orifice cup and a guide member in the related art.

[FIG. 4] FIG. 4 is a sectional view of a line A-A of FIG. 3, illustrating a seat portion from upstream.

[FIG. 5] FIG. 5 is a view enlarging a vicinity of the seat portion of FIG. 4 and illustrating flows into and out of injection holes.

[FIG. 6] FIG. 6 is a cross sectional view of an injection hole 71 of FIG. 5.

[FIG. 7] FIG. 7 is a contour diagram of an outlet portion 81 of the injection hole 71 of FIG. 5.

[FIG. 8] FIG. 8 is a cross sectional view of an injection hole 72 of FIG. 5.

[FIG. 9] FIG. 9 is a contour diagram of an outlet portion 82 of the injection hole 72 of FIG. 5.

[FIG. 10] FIG. 10 is a view enlarging a vicinity of a seat portion with a twist angle and illustrating flows into and out of injection holes according to an embodiment of the present invention.

[FIG. 11] FIG. 11 is top and side views of a guide member illustrating an embodiment of the present invention.

### DESCRIPTION OF EMBODIMENTS

In the present embodiment, each injection hole is formed such that an inlet thereof is opened at a substantially conical surface with a diameter thereof on an upstream side larger than one on a downstream side. A seat portion contacted by a valve element is provided on the substantially conical surface, and the inlet of the injection hole is formed downstream of the seat portion. Upstream of the seat portion, a member for guiding the valve element is fixed to a cup-shaped member forming the injection hole, and a groove is formed on an outer peripheral surface of the guide member or inside thereof. The groove formed in the guide member has a fixed twist angle to a central axis line of a fuel injection valve. This fuel passage groove may be plurally formed, but may be in any shape as long as twist angles are set nearly equal to one another and the fuel passage shape is set smaller than an upstream passage area and larger than a passage area of the seat portion. This twisted fuel passage twists fuel while the valve element is opened, that is, a swirling component is applied. In order to uniform this swirling component, the twist angles of the fuel passage grooves are set nearly equal to one another and the fuel passage shape is set substantially symmetrical to an axis line of the fuel injection valve. Due to nearly uniform swirling component of a fuel flow, an inflow direction at an injection hole inlet changes with an angle. However, a direction of an injection hole outlet is predetermined. Therefore, a fluid flows toward this direction of the injection hole outlet. Thus, when an angle between the inflow direction at the injection hole inlet and the direction at the injection hole outlet is defined as α (0° to 90°), a flow along an injection hole axis becomes dominant without twists in the fuel flow in a case where α is a small angle. Therefore, a spray to be ejected from the injection hole outlet is ejected along the axial direction and forms a long spray penetration in the direction of the injection hole outlet. However, in a case where the angle α is large, the flow that has flowed into the injection hole is forcibly provided with components with twists. Therefore, flow components perpendicular to the injection hole axis (that is, in-plane flow rate) are likely to increase. An increase in this in-plane flow rate causes the spray to be ejected from the injection hole outlet to have a vector with components perpendicular to the spray along the axial direction and the axis. Therefore, due to the components perpendicular to the axis at the injection hole outlet, the spray is ejected in a direction spreading in the direction perpendicular to the axis, and is likely to spread. Furthermore, a spray speed in a direction of the injection hole axis is relatively slowed down. Therefore, the spray penetration into the direction of the injection hole axis is expected to be shortened. Thus, the spray penetration can be shortened by setting the angle between the injection hole inlet and the direction of the injection hole outlet larger.

On the other hand, in a case where the injection hole is set on a central axis with a center of a connector portion as an axis, the angle α may not be set larger than at other injection holes. In this case, the spray penetration is lengthened. Thus, at a second injection hole set adjacent to a first injection hole and at a third injection hole set except the injection holes, nonuniform pitch angles among the holes as well as stronger flows into the second injection hole by a smaller angle α due to a smaller inflow angle of a fluid into the second injection hole can shorten the spray penetration at the first injection hole.

The present embodiment will be described below in detail with reference to the drawings.

FIG. 1 is a longitudinal sectional view illustrating an overall configuration of a fuel injection valve according to an embodiment of the present invention. The fuel injection valve according to the present embodiment is a fuel injection valve that injects a fuel such as gasoline directly to an engine cylinder (combustion chamber).

A fuel injection valve body 1 has a hollow fixed core 2, yoke 3 serving also as a housing, mover 4, and nozzle body 5. The mover 4 includes a movable core 40 and a movable valve element 41. The fixed core 2, yoke 3, and movable core 40 are components of a magnetic circuit.

The yoke 3, nozzle body 5, and fixed core 2 are connected by welding. There are various types in this connecting manner, but in the present embodiment, the nozzle body 5 and the fixed core 2 are connected by welding with a part of an inner periphery of the nozzle body 5 fitted into a part of an outer periphery of the fixed core 2. In addition, the nozzle body 5 and the yoke 3 are connected by welding such that a part of an outer periphery of this nozzle body 5 is surrounded by the yoke 3. An electromagnetic coil 6 is installed inside the yoke 3. The electromagnetic coil 6 is covered, with seal performance maintained, by the yoke 3, a resin cover 23, and a part of the nozzle body 5.

Inside the nozzle body 5, the mover 4 is installed movably in the axial direction. At a tip of the nozzle body 5, an orifice cup 7 forming a part of the nozzle body is fixed by welding. The orifice cup 7 has injection holes (orifices) 71 to 76, which will be described later, and a conical surface 7A including a seat portion 7B.

Inside the fixed core 2, a spring 8 that presses the mover 4 against the seat portion 7B, and an adjustor 9 and a filter 10 that adjust a spring force of this spring 8.

Inside the nozzle body 5 and the orifice cup 7, a guide member 12 that guides movement of the mover 4 in the axial direction is installed. The guide member 12 is fixed to the orifice cup 7. A guide member 11 that guides the movement of the mover 4 in the axial direction near the movable core 40 is installed. The mover 4 is guided in the movement in the axial direction by the guide members 11 and 12 vertically arranged.

The valve element (valve rod) 41 according to the present embodiment is illustrated as a needle type with a tapered tip, but may be a type with a spherical body at the tip.

A fuel passage in the fuel injection valve includes an inside of the fixed core 2, a plurality of holes 13 provided in the movable core 40, a plurality of holes 14 provided in the guide member 11, an inside of the nozzle body 5, a plurality of side grooves 15 provided in the guide member 12, and the conical surface 7A including the seat portion 7B.

The resin cover 23 is provided with a connector portion 23A that supplies excitation current (pulse current) to the electromagnetic coil 6, and a part of a lead terminal 18 insulated by the resin cover 23 is positioned in the connector portion 23A.

Excitation of the electromagnetic coil 6 housed in the yoke 3 by an external driving circuit (not illustrated) via this lead terminal 18 causes the fixed core 2, yoke 3, and movable core 40 to form a magnetic circuit, and the mover 4 to be magnetically attracted against the force of the spring 8 toward the fixed core 2. At this time, the valve element 41 is opened separated from the seat portion 7B, and a fuel in the fuel injection valve body 1, boosted in advance (1 MPa or higher) by an external high pressure pump (not illustrated), is injected from the injection holes 71 to 76.

Turning off the excitation of the electromagnetic coil 6 causes the valve element 41 to be closed, pressed toward the seat portion 7B by the force of the spring 8. Here, a main fuel passage from the guide member 12 into the injection holes 71 to 75 through the seat portion 7B will be described. When a fluid flows downstream from the guide member 12, the flow is divided into a small space AA to be formed by the guide member 12 and the movable valve element 41, and a plurality of side grooves 15 provided in the guide member 12. However, an area of the space AA is far smaller than one to be formed by the side grooves 15, and the flow of the fluid concentrates in the side grooves 15. Therefore, the flow passing through each side groove 15, seat portion 7B, and injection holes 71 to 75 is called a main fuel passage. As illustrated in FIG. 2, the side groove 15 of the guide member 12 forms the fuel passage so as to be in a direction parallel to a fuel injection valve axis O1. Therefore, after the fuel passes through the side groove 15, the fluid contracts with a decrease in a passage area toward the seat portion 7B, but a flow vector passes in a direction along the conical surface of the orifice cup 7 and in nearly the same direction as the fuel injection valve axis O1. An A-A section of FIG. 3 is illustrated in FIG. 4. The orifice cup 7 is illustrated, viewed from an upstream side and excluding the valve element 41 so a to show the seat portion 7B. Flows of the fluid near this seat portion 7B are illustrated in FIG. 5. As described above, the flows proceed in nearly the same direction as the conical surface and the fuel injection valve axis O1. Therefore, in passing through the seat portion 7B, the fluid flows nearly radially from outside of the conical surface toward a center of the fuel injection valve. Inflow arrows 101 to 105 into the injection holes 71 to 75 face substantially in a central axial direction of the fuel injection valve. Here, FIG. 5 indicates inlets of the injection holes 71 to 75 with solid lines 81 to 85, outlets thereof with dotted lines 91 to 95, and directions of the injection hole outlets with arrows 201 to 205. An axis line passing through a center of the injection hole inlet 81 and the injection hole outlet 91 is O101. Similarly, a central axis line of each injection hole is O102, O103, O104, and O105. A flow inside the injection hole 71 on a plane passing through the axis line O103 and the fuel injection valve axis line O1 is illustrated in FIG. 6. A flow on a plane perpendicular to the axis line O103 and passing through the inject on hole outlet 93 is illustrated in FIG. 7. At an injection hole 73, the inflow direction 103 and the outlet direction 203 are nearly the same. Therefore, a speed component in a direction of the axis line O103 in FIG. 6 is large. Thus, the fluid from the injection hole outlet 93 is ejected with a fast speed component in a direction of a vertical axis. On the other hand, at the injection hole 71, the angle α (α; 0° to 90°) between the inflow direction 101 and the outlet direction 201 is applied This angle α generates the twist effect in the fluid inside the injection hole. This twist shows that a speed in a direction of a plane component perpendicular to the direction of the axis line O101 (hereinafter cal led in-plane flow rate) is applied. This application of the in-plane flow rate reduces the speed in the direction of the axis line O101, when the fluid is ejected from the injection hole outlet 81, and the fluid proceeds in the direction of the plane perpendicular to the axis line O101, that is, in a spreading direction. A flow inside the injection hole 71 on a plane passing through the axis line O101 and the fuel injection valve axis line O1 is illustrated in FIG. 8. A flow on a plane perpendicular to the axis line O101 and passing through the injection hole outlet 91 is illustrated in FIG. 9. Shown below is an embodiment according to the present invention that in a case where the twist angle α cannot be actively applied at the injection hole 73, the flow flowing into the injection hole 73 is suppressed by arrangement of other injection holes.

As illustrated in FIG. 10, the angle α may not be set larger at the injection hole 73 than at other injection holes. In this case, the spray penetration is lengthened. Thus, at injection holes 72 and 74 set adjacent to the injection hole 73 and at injection holes 71 and 75 set adjacent otherwise, nonuniform pitch angles β1 and β2 among the holes as well as stronger flows into the injection holes 72 and 74 by a smaller angle α due to a smaller inflow angle β1 of a fluid into the injection holes 72 and 74 can shorten the spray penetration at the injection hole 73. On the other hand, it is possible to shorten the spray penetration by making the angle α larger by

setting the inflow angle β2 of the fluid at the injection holes 71 and 75 illustrated in FIG. 10 larger than the inflow angle β1 of the fluid into the injection holes 72 and 74. A flow on a plane perpendicular to the axis line of each injection hole and passing through the injection hole outlet is indicated in FIG. 11. Comparison of the drawings on the right and left sides of FIG. 11 shows that the speed component in a direction of the axis line O103 is suppressed at the injection hole 73. This is because the inflow angle β1 of the fluid into the injection holes 72 and 74 is set smaller and the flows into the injection holes 72 and 74 are strengthened.

### REFERENCE SIGNS LIST

1 fuel injection valve body

2 hollow core

3 yoke

4 mover

5 nozzle body

6 electromagnetic coil

7 orifice cup

8 spring

9 adjustor

10 filter

11 guide

12 guide member (PR guide)

13 fuel passage (anchor)

14 fuel passage (rod guide)

15 side groove (PR guide)

18 lead terminal

23 resin cover

23A connector portion

40 movable core

41 movable valve element

71 to 75 injection hole

7A conical surface

7B valve seat portion

81 to 85 injection hole inlet

91 to 95 injection hole outlet

101 to 105 injection hole inflow direction by a conventional guide member

201 to 205 direction of injection hole outlet

O1 central axis of fuel injection valve

O101 to O105 central axis of injection hole

1. A fuel injection valve for use in an internal combustion engine for an automobile, comprising:
a plurality of injection holes;
a seat portion provided on an upstream side of the injection holes; and
a valve element that is closed by contact with the seat portion and is opened by separation from the seat portion,
wherein, of the injection holes, at a first injection hole set on a central axis with a center of a connector portion as an axis, a second injection hole set adjacent to the first injection hole, and a third injection hole set adjacent to the second injection hole, each pitch angle among the injection holes is nonuniform.

2. The fuel injection valve according to claim 1, wherein an inflow angle of a fluid into the second injection hole is set less than 60° and at an angle separated from each of the injection holes.

3. The fuel injection valve according to claim 2, wherein a difference between inflow and outflow angles of a fluid at the third injection hole is larger than ones at the second injection hole.

4. The fuel injection valve according to claim 3,
wherein a diameter of the first injection hole is smaller than ones of other injection holes, or
the first injection hole is removed.
